(19) United States
(12) Patent Application Publication
(10) Pub. No.: US 2025/0012733 A1
(43) Pub. Date: Jan. 9, 2025

(54) Apparatus and method for side-wall inspection of pulp containers

(71) Applicant: Krones AG, Neutraubling (DE)

(72) Inventor: Peter LINDNER, Langquaid (DE)

(21) Appl. No.: 18/760,917

(22) Filed: Jul. 1, 2024

(30) Foreign Application Priority Data
Jul. 4, 2023 (DE) 102023117655.2

(51) Int. Cl. G01N 21/95; H04N 23/56; H04N 23/90

(52) U.S. Cl. CPC G01N 21/95; H04N 23/56; H04N 23/90

(57) ABSTRACT

The present disclosure relates to an apparatus for optically inspecting a pulp container. The apparatus comprises a lighting device, wherein a mouth of the pulp container can be arranged below the lighting device such that light from the lighting device can be emitted into the pulp container through the mouth of said container, and a camera which is configured to register light passing through a side wall of the pulp container and thus to capture an image of the side wall of the pulp container. The present disclosure further provides a method for optically inspecting a pulp container.

### CROSS REFERENCE TO RELATED APPLICATION

The present application claims priority to German Patent Application No. 10 2023 117 655.2 filed on Jul. 4, 2023. The entire contents of the above-listed application are hereby incorporated by reference for all purposes.

### TECHNICAL FIELD

The present disclosure relates to an apparatus and to a method for side-wall inspection of pulp containers.

### BACKGROUND

Before containers, such as beverage bottles and cans, can be used for filling, it must be ensured that they do not have any damage such as cracks or holes, and that they are not contaminated. To this end, transparent containers can be checked for contamination, foreign bodies or damaged areas from the outside by means of transmitted light. For opaque cans, there are inner-wall inspections in which light from a large-surface-area light source is emitted through the large can mouth, which is approximately the same diameter as the can. Apparatuses for the optical inspection of containers are known, for example, from DE 11 2016 002 237 T5 and DE 10 2017 123 684 A1.

### SUMMARY

Pulp containers, however, are made of diffuse, largely opaque material, which means that the interior cannot be directly inspected from the outside. Nevertheless, in industrial applications it is necessary to enable efficient inspection of the pulp container for damage and contamination before it is filled in a filling plant.

Therefore, it is an object of the present disclosure to provide an apparatus and a method which enable reliable and efficient inspection of pulp containers for contamination or damage. For this purpose, the disclosure provides an apparatus according to claims 1 and 4 and a method according to claims 9 and 11.

According to the disclosure, the apparatus for optically inspecting a pulp container comprises a lighting device, wherein a mouth of the pulp container can be arranged below the lighting device such that light from the lighting device can be emitted into the pulp container through the mouth of said container, and a camera. The camera is configured to register light passing through a side wall of the pulp container and thus to capture an image of the side wall of the pulp container.

Using this apparatus, it is therefore possible to emit light into the interior of a pulp container and to observe the side wall of the pulp container with a camera. If there is damage in the form of a hole or a crack in the side wall, the light passes through this damaged area and is captured by the camera. In the image captured by the camera, the damaged area can thus be seen as a bright spot and can be clearly identified. The apparatus is also suitable if there are areas with a smaller wall thickness in the side wall of the pulp container. Again, this area would appear brighter in the captured image than the surrounding areas on the side wall. An area in the side wall with a smaller wall thickness is also included under the broader term of a damaged area. Overall, the apparatus described can thus be used to efficiently and reliably detect damaged areas in the side wall of the pulp container.

The pulp container can consist entirely or predominantly of a mixture of water, fibers and possibly other additives, this mixture being known as pulp. The fibers can be of natural origin and biodegradable. The fibers may comprise lignin, banana leaves and/or wild quinine. The fibers may, for example, comprise cellulose fibers, fibers of conifers, of leafy woody plants and/or plane trees and/or grasses, reeds and/or bamboo or the like. The fibers may comprise silk threads, spider silk, algae, natural fibers (such as cup-plant fibers, hemp, maize, cotton), banana peel, orange peel, grass, straw, potato starch or processed cow dung. It is also possible to provide cellulose fibers which originate from a process by which they were artificially grown. In the event of material bottlenecks of wood as the basic material for a fluid mass with fibers, these alternative materials can completely or partially replace the basic material. The fibers can likewise comprise fiber mixtures made of non-wood material, for example cotton, hemp and/or textile fibers.

An inner wall of the pulp container refers to the entire area that delimits the interior or the inside of the pulp container. This includes, for example, the container bottom (hereinafter also referred to as the bottom), the side wall and/or, if applicable, a container neck (for example in the case of a bottle). Alternatively, the side wall can also be called a casing. When viewed from the outside too, the boundaries of the pulp container are defined by the container bottom, the side wall and, if applicable, the container neck.

The camera can further be configured to detect a label applied to the side wall of the pulp container or an imprint applied to the side wall of the pulp container.

Besides inspecting for damage, as described at the outset, the apparatus additionally allows what is known as an imprint inspection to be carried out. The captured image of the label or imprint can be compared with a template in order to identify any deviations between the image and the template. An inspection for damage and a check for the correct label or imprint can thus take place in the same apparatus, which increases the efficiency of the check and does not require a separate apparatus for imprint inspection.

The lighting device can further comprise a light source and an optical system having a reflector and/or a lens, so that the optical system is configured in such a way that light from the light source can be radiated through the mouth of the pulp container.

The optical system allows the beam path of the light from the light source to be precisely adjusted so that as large a proportion of the light as possible is radiated through the mouth into the interior of the pulp container. This ensures good illumination of the interior of the pulp container and at the same time a lower light output requirement for the light source. In particular, the optical system can be configured in such a way that it acts like an objective with a large depth of field. This allows as large a region of the side wall of the pulp container as possible between the mouth and the bottom to be evenly illuminated, allowing efficient optical inspection.

The apparatus can comprise a further lighting device which is configured to diffusely illuminate the side wall of the pulp container from the outside. In particular, the further lighting device can be arranged concentrically around the lighting device and above the mouth of the pulp container.

The further lighting device enables good lighting conditions for imprint inspection (contrast, exposure) and thus ensures a reliable imprint inspection. In particular, a particularly uniform illumination of the outside of the pulp container can be achieved by means of a further lighting device arranged concentrically around the lighting device and above the mouth. This makes recognition of the label or imprint more reliable.

The disclosure further provides an apparatus for optically inspecting a pulp container comprising a lighting device and a camera arranged above the pulp container and directed towards the mouth of said container. The pulp container can be arranged relative to the lighting device in such a way that the light from the lighting device penetrates through a side wall and/or a bottom of the pulp container into the interior of the pulp container, and the camera is configured to register the light from the interior of the pulp container and thus to capture an image of the interior of the pulp container.

The pulp is partially translucent, so that some light passes through the wall and is diffusely emitted in all directions in the interior of the pulp container. If the pulp has a low absorption, the light inside the pulp container strikes the inner wall multiple times, each time resulting in a diffuse distribution of the light. This ensures that the interior is evenly illuminated. As a result, good exposure conditions are created for image recording through the mouth of the pulp container, so that contamination, foreign bodies and/or damaged areas can be reliably detected both on the bottom and on/in the side wall of the pulp container.

The light provided by the lighting device can be or comprise near-infrared light, in particular in the wavelength range between 800 nm and 1500 nm.

Absorption of light by the pulp of the container and imprints on the outside of the side wall of the pulp container impair the illumination of the interior of the pulp container and thus make it difficult to detect contamination and foreign bodies. Experiments have shown that light from this part of the electromagnetic spectrum is better transmitted through pulp than visible light. In addition, many organic colors used for imprints have a higher transmission in the near-infrared range or are virtually translucent. By choosing a suitable wavelength and color for the imprint, the influence of the imprint on the optical inspection can be reduced or even avoided.

However, the pulp container can also be illuminated with visible light, for example in the range between 350 nm and 800 nm. The spectrum used can be the same for the lighting device and the further lighting device. Furthermore, the illumination by the lighting device and/or the further lighting device can be pulsed, i.e., provide pulsed light or light pulses. LEDs, in particular chip-on-board LEDs (COB LEDs), are suitable for this purpose. The duration of a light pulse can be between 2 us and 1 ms.

The lighting device and the further lighting device can be controlled separately and independently of each other with regard to the spectrum, the power, the switch-on and switch-off times and/or the pulse duration.

The lighting device can be configured such that the side wall of the pulp container is diffusely illuminated.

In this context, the term “diffusely” means in particular that the side wall is completely illuminated, optionally with a spatially almost constant illuminance. This can be achieved, for example, with a lighting device that completely surrounds the side wall of the pulp container. Diffusely illuminating the side wall makes it possible to diffusely illuminate the interior of the pulp container, which, as previously described, leads to more reliable detection of foreign bodies, contamination and/or damaged areas.

The apparatus can further comprise a holder with which a pulp container arranged thereon can be rotated about the longitudinal axis of said container. The holder can be provided for both described forms of the apparatus, i.e., when the pulp container is illuminated through its mouth and when the side wall of the pulp container is illuminated from the outside.

The lighting device and the camera are mainly fixed in place and the pulp container is moved relative to the lighting device and the camera. There are essentially two advantages to rotation about the longitudinal axis at the same time as viewing through the camera. Firstly, when the lighting device is designed such that it does not completely surround the side wall of the pulp container, diffuse illumination of the side wall and thus also of the interior can be achieved. When the interior of the pulp container is illuminated through the mouth of said container, the rotation of the pulp container allows the entire side wall to still be inspected for damage using a stationary camera. Secondly, an imprint inspection can be carried out on the entire side wall. Any errors on an imprint or label are therefore reliably detected.

The apparatus can further comprise a transport apparatus, the transport apparatus being transparent or translucent so that the pulp container can be illuminated through the transport apparatus.

The described light coupling through the side wall of the pulp container occurs, for example, when the pulp container is located on a conveyor. Light coupling through the bottom can be achieved, for example, by means of neck handling, in which the pulp container is transported in suspension. The advantage of a transparent or translucent transport apparatus is that the lighting device and the camera can be integrated into the existing transport apparatus and no separate apparatus for optical inspection is required. The entire system can therefore be designed more simply and more space-efficiently.

The apparatus can also comprise a linear conveyor, such as a conveyor belt, for transporting the pulp container, the conveyor being in particular a single-aisle conveyor. The apparatus can further comprise an arrangement of a plurality of cameras in order to achieve an all-round view of the pulp container. For example, the arrangement comprises four cameras, two of which are arranged next to the conveyor. The two cameras on each side can form an angle of between 60 and 90 degrees, in particular between 70 and 90 degrees, with respect to the container.

Alternatively, an all-round view of the pulp container can also be achieved with a mirror cabinet.

The present disclosure further provides a method for optically inspecting a pulp container. The method comprises illuminating a part of an inner wall of the pulp container through the mouth of said container by means of a lighting device, and capturing an image by means of a camera by registering light that passes through a side wall of the pulp container and strikes the camera.

The advantages described in connection with the apparatus apply equally to the method described below.

Part of the method can be that a label attached to the side wall of the pulp container is detected by means of the camera.

In addition to illuminating the side wall of the pulp container through the mouth of said container, the side wall can also be illuminated from the outside. This can be achieved in particular by means of a further lighting device, which is arranged, for example, concentrically around the lighting device and above the mouth.

The method can be extended by capturing a further image (or second image). In this method, a first image is captured by registering light that passes through the side wall of the pulp container and strikes the camera. A second image is captured by allowing the light from the further lighting device that is reflected or scattered on the outside of the side wall to strike the camera. In the process the further lighting device illuminates the outside of the side wall, for example diffusely.

The two images can be captured in particular during a transport process of the pulp container. For this purpose, the second image is captured approximately 100 us or less, in particular approximately 50 us or less, after the first image. For this purpose, the lighting device and the further lighting device must also be configured to provide light pulses at the two times of light absorption with the specified duration.

In the method described, the pulp container can be rotated about its longitudinal axis, wherein simultaneously a label applied to the side wall of the pulp container is detected.

This method allows a comprehensive inspection of the pulp container. Firstly, as described, a reliable and complete inspection of the side wall of the pulp container for damage can be carried out. Secondly, an imprint inspection on the entire side wall and optionally a contour measurement of the container can also be carried out. The method thus combines two key steps of quality control of pulp containers in an efficient manner.

A further method for optically inspecting a pulp container comprises illuminating a part of a side wall and/or a bottom of the pulp container by means of a lighting device so that some of the light shines through the side wall and/or the bottom into the interior of the pulp container, and capturing an image of the interior of the pulp container by means of a camera by registering light that strikes the camera through the mouth of the pulp container.

As previously described, this method allows reliable detection of foreign bodies, contamination and/or damaged areas on/in the bottom and/or on/in the side wall of the pulp container.

The light from the lighting device can be or comprise near-infrared light, in particular in the wavelength range between 800 nm and 1500 nm.

As already described in connection with the apparatus, light or electromagnetic radiation from this wavelength range is better transmitted through the pulp and any imprints on the side wall of the pulp container.

The side wall of the pulp container can be diffusely illuminated.

It is understood that the methods described can be suitably carried out by means of the apparatuses described herein.

### BRIEF DESCRIPTION OF THE FIGURES

Further features and advantages are explained below with reference to the exemplary figures. Shown are:

FIG. 1 is a schematic representation of an apparatus for optically inspecting a pulp container according to a first embodiment;

FIG. 2 is a schematic representation of an apparatus for optically inspecting a pulp container according to a second embodiment;

FIG. 3 is a schematic representation of an apparatus for optically inspecting a pulp container according to a third embodiment; and

FIG. 4 is a schematic representation of an apparatus for optically inspecting a pulp container according to a fourth embodiment.

### DETAILED DESCRIPTION

In the following and in the figures, the same reference signs are used for identical or corresponding elements in the various embodiments, unless otherwise specified.

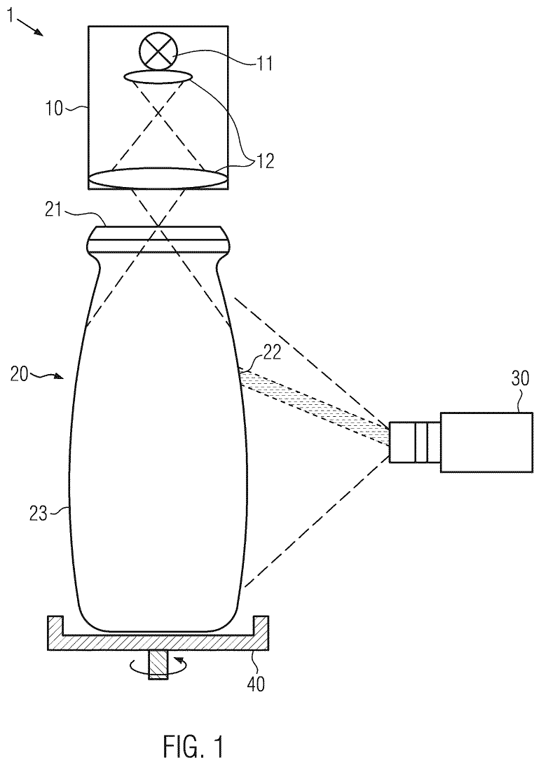

FIG. 1 shows an apparatus 1 for optically inspecting a pulp container 20 according to a first embodiment of the present disclosure as a schematic side view. The apparatus 1 comprises a lighting device 10 which is arranged above a pulp container 20. The pulp container 20 itself has a bottom, a side wall 23 and a mouth 21. A damaged area 22 in the form of a hole or a crack is formed in the side wall 23. The pulp container 20 is further arranged on a holder 40. The holder 40 is configured to rotate the pulp container 20 about the longitudinal axis of said container. The rotation can in particular be continuous and/or at an angle greater than or equal to 360 degrees.

The lighting device 10 shown comprises not only a light source 11 but also an optical system 12, in this case consisting of two convex lenses. It is understood, however, that the optical system 12 is not limited to the number of lenses shown, nor to their shape, and can, for example, be a system consisting of a concave lens and a convex lens. The optical system 12 serves the purpose of illuminating the interior of the pulp container better than the light source 11 alone could achieve. For this purpose, the light from the light source 11 is directed in such a way that it is emitted through the mouth 21 into the interior of the pulp container 20. The optical system 12 achieves a higher irradiation of light through the mouth, so that the light yield is higher or a lower luminous power is required for the light source 11.

The apparatus 1 further comprises a camera 30 which is directed toward the side wall 23 of the pulp container 20. The camera 30 is configured to register light passing through the side wall 23 and to capture an image accordingly. Because the pulp container 20 is arranged on a rotating holder 40, the camera 30 can inspect the entire side wall 23.

In the example shown, the side wall has a damaged area 22 through which light passes through the side wall 23 and is captured by the camera 30. In the image captured by the camera 30, this damaged area appears as an illuminated area compared with the surroundings. As a result, the damaged area 22 is reliably detected and the pulp container 20 is accordingly identified as defective.

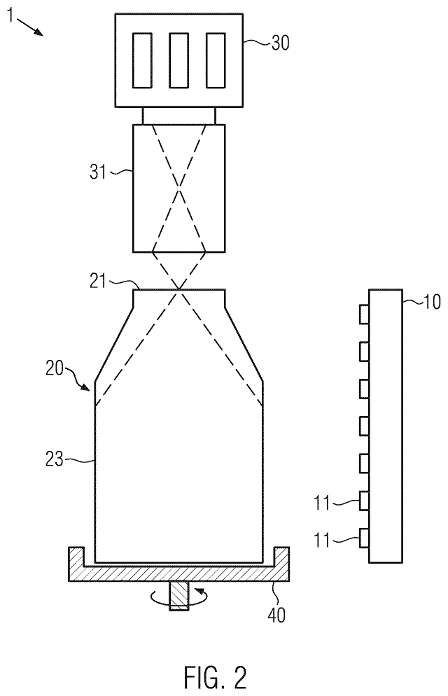

FIG. 2 shows an apparatus 1 for optically inspecting a pulp container 20 according to a second embodiment of the present disclosure as a schematic side view. The apparatus 1 firstly comprises a lighting device 10 which is configured to emit light. The lighting device 10 is arranged in such a way that a pulp container 20 can be positioned therebeside, so that a side wall 23 of the pulp container 20 is irradiated with the light. Since pulp is partially translucent, some of the light is transmitted into the interior of the pulp container 20, so that the interior of the pulp container 20 is illuminated. In the example shown, the lighting device 10 is adjusted in terms of its height to the pulp container 20 to ensure that the entire side wall 23 of the pulp container 20 is illuminated.

The lighting device 10 can comprise a plurality of light sources 11, for example LEDs, which are arranged on the lighting device 10. The number of light sources 10b shown and their arrangement should by no means be interpreted as restrictive. For example, the light sources 10b can also be what are known as chip-on-board LEDs, which are arranged close together in order to achieve a high luminance. A high luminance is advantageous for achieving good illumination of the interior of the pulp container 20 and improving the reliability of the detection of damaged areas or contamination.

Furthermore, the lighting device can emit light in the near-infrared range, for example with a wavelength between 800 nm and 1500 nm. As previously explained, near-infrared light is advantageous because it is better transmitted through the pulp and organic colors. In this case, an imprint on the pulp container does not affect the optical inspection.

The apparatus further comprises a camera 30 which registers light from the interior of the pulp container 20 that passes through the mouth 21 of the pulp container 20 and thus generates an image of the interior of the pulp container 20. In this way, damaged areas, foreign bodies and/or contamination on the bottom or on the side wall 23 of the pulp container 20 are detected and the container in question is accordingly identified as defective.

The pulp container 20 is arranged on a holder 40 which is configured to rotate the pulp container 20 about its (here vertical) longitudinal axis (shown by the arrow). The advantage of this is that the side wall 23 can be diffusely illuminated without the need for the lighting device 10 to completely surround the side wall 23 of the pulp container. Diffuse illumination of the side wall 23 automatically also leads to diffuse illumination of the interior of the pulp container, which provides good conditions for the exposure of the image captured by the camera. This ensures a high level of reliability in the detection of foreign bodies, contamination and/or damaged areas through high image quality.

Alternatively, the apparatus 1 described in the second exemplary embodiment can also provide illumination of the pulp container 22 through the bottom of said container. For this purpose, the holder 40 on which the pulp container 20 is arranged can serve as a transport apparatus and can be transparent, for example by virtue of the holder 40 being made of plexiglass, glass or another transparent material. Accordingly, the light source 10 must be arranged below the holder 40 and directed toward the bottom of the pulp container 20. Instead of the holder 40, the apparatus can also comprise a device for neck handling as a transport apparatus, so that the bottom of the pulp container 20 can be directly illuminated.

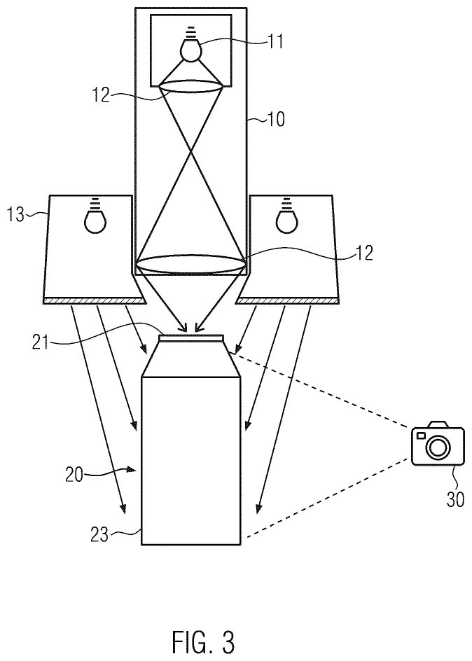

FIG. 3 shows a third embodiment of the described apparatus 1. This differs from the first embodiment in that it comprises a second lighting device 13. The second lighting device 13 is arranged concentrically around the lighting device 10. The second lighting device 13 is configured to diffusely illuminate the side wall 23 of the pulp container 20. The camera 30 can use this incident light to check a label applied to the side wall 23 or an imprint.

It is understood that this embodiment can be combined, for example, with a holder to rotate the container about the longitudinal axis of said container. In this way, the side wall can be inspected all around (360° view) for damage as well as for the correctness of a label or imprint.

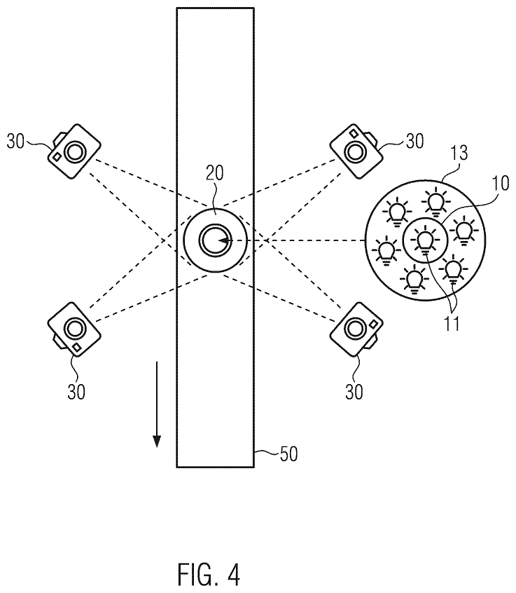

FIG. 4 shows an apparatus 1 for optically inspecting a pulp container 20 according to a further embodiment as a plan view, which differs from the previously described third embodiment in the following aspects. The lighting device 10 and the further lighting device 13 are shown schematically next to the pulp container 20; however, the configuration is to be understood in such a way that the lighting devices 10, 13 are located above the pulp container 20 as shown in FIG. 3.

First, the apparatus 1 comprises a linear conveyor 50, for example a conveyor belt, which is configured in particular as a single-aisle conveyor. Compared to a holder, the conveyor 50 has the further advantage that a large number of containers can be transported in series, whereas otherwise a plurality of individual holders with associated transport mechanisms would have to be provided. Furthermore, the apparatus 1 comprises an arrangement of a plurality of cameras 30, in this example four cameras 30, two cameras 30 being arranged on each of the two sides of the conveyor 50. The arrangement is in particular symmetrical with respect to the conveyor. It should be understood, however, that the number of cameras is not limited to this example.

The two cameras 30 on a given side of the conveyor 50 form an angle with respect to the pulp container 20, which in the example shown is approximately 60 degrees. However, the angle can be between 60 and 90 degrees. By arranging the cameras 30 thus, an all-round view of the side wall 23 of the pulp container can be achieved, for example without the container 20 being positioned on a rotatable holder. This simplifies the resulting design and a large number of containers can be checked in a specific time.

In particular, through interaction with the two lighting devices described, an inspection for damaged areas and an imprint inspection of the entire side wall 23 (360 degree view) can be carried out. For this purpose, the two lighting devices 10, 13 are pulsed light sources that only provide light during a specific period of time. For the first image, the lighting device 10 is switched on and the cameras 30 check whether light is passing through the side wall 23 of the pulp container 20. In this way, damaged areas are identified. For the second image, the lighting device 13 is switched on in order to diffusely illuminate the side wall 23 from the outside. This is for the imprint inspection. This method can be carried out by means of a camera 30 and by means of an arrangement of a plurality of cameras 30.

At a typical transport speed on the conveyor of around 2 m/s, this corresponds to a spatial offset of the container of only 0.1 mm between the two image captures. This offset is small enough that the two images can be compared. Only one camera is thus needed to simultaneously check moving containers for damage and to carry out an imprint inspection.

1. Apparatus for optically inspecting a pulp container, comprising:
a lighting device, wherein a mouth of the pulp container can be arranged below the lighting device such that light from the lighting device can be emitted into the pulp container through the mouth of said container; and
a camera which is configured to register light passing through a side wall of the pulp container and thus to capture an image of the side wall of the pulp container.

2. Apparatus according to claim 1, wherein the camera is further configured to detect a label applied to the side wall of the pulp container or an imprint applied to the side wall of the pulp container.

3. Apparatus according to claim 1, wherein the lighting device comprises:
a light source; and
an optical system having a reflector and/or a lens,
so that the optical system is configured in such a way that light from the light source is radiated through the mouth of the pulp container.

4. Apparatus according to claim 1, further comprising a further lighting device for diffusely illuminating the side wall of the pulp container from the outside,
wherein the further lighting device is arranged concentrically around the lighting device and above the mouth of the pulp container.

5. Apparatus for optically inspecting a pulp container, comprising:
a lighting device; and
a camera arranged above the pulp container and directed towards the mouth of said container,
wherein the pulp container can be arranged relative to the lighting device in such a way that the light from the lighting device penetrates through a side wall and/or a bottom of the pulp container into the interior of the pulp container, and
wherein the camera is configured to register the light from the interior of the pulp container and thus to capture an image of the interior of the pulp container.

6. Apparatus according to claim 5, wherein the lighting device is configured in such a way that the side wall of the pulp container is diffusely illuminated.

7. Apparatus according to claim 5, further comprising a holder with which a pulp container arranged thereon can be rotated about the longitudinal axis of said container.

8. Apparatus according to claim 5, further comprising a linear conveyor for transporting the pulp container, and one or more further cameras,
wherein the cameras are arranged on both sides of the conveyor and are oriented in such a way that light from the pulp container strikes the cameras.

9. Method for optically inspecting a pulp container, comprising:
illuminating a part of an inner wall of the pulp container through the mouth of said container by means of a lighting device, and
capturing an image by means of a camera by registering light that passes through a side wall of the pulp container and strikes the camera.

10. Method according to claim 9, wherein a label attached to the side wall of the pulp container is detected by means of the camera.

11. Method according to claim 10, wherein the pulp container is rotated about its longitudinal axis, and
wherein simultaneously a label applied to the side wall of the pulp container or an imprint applied to the side wall of the pulp container is detected.

12. Method according to claim 9, further comprising:
illuminating the side wall of the pulp container from the outside by means of a further lighting device, and
capturing a further image by means of the camera by allowing the light from the further lighting device that is reflected or scattered on the outside of the side wall to strike the camera and be registered.

13. Method according to claim 12, wherein the lighting device and the further lighting device each provide light pulses, and
wherein the image and the further image are captured at a time interval of 100 us or less.

14. Method according to claim 9, wherein the light of the lighting device is or comprises near-infrared light.

15. Method according to claim 14, wherein the light of the lighting device has a wavelength range between 800 nm and 1500 nm.
